(19) United States
(12) Patent Application Publication
(10) Pub. No.: US 2026/0144262 A1
(43) Pub. Date: May 28, 2026

(54) COMPOUND REGULATOR FOR ALLEVIATING COMBINED DROUGHT AND HIGH-TEMPERATURE STRESS IN CORN AND APPLYING METHOD THEREOF

(71) Applicant: Henan Agricultural University, Zhengzhou (CN)

(72) Inventors: Ruixin Shao, Zhengzhou (CN); Yulou Tang, Zhengzhou (CN); Shancong Wang, Zhengzhou (CN); Fanzheng Meng, Zhengzhou (CN); Xinru Hu, Zhengzhou (CN); Yifei Sun, Zhengzhou (CN); Meiyu Chen, Zhengzhou (CN); Qinghua Yang, Zhengzhou (CN); Yongchao Wang, Zhengzhou (CN); Jiameng Guo, Zhengzhou (CN); Hao Wang, Zhengzhou (CN); Qihang Yu, Zhengzhou (CN); Reda M.M. Ahmed, Zhengzhou (CN)

(21) Appl. No.: 19/201,917

(22) Filed: May 8, 2025

(30) Foreign Application Priority Data
Nov. 26, 2024 (CN) 202411703407.0

(51) Int. Cl. A01N 63/22; A01N 37/10; A01N 37/44; A01P 21/00

(52) U.S. Cl. CPC A01N 63/22; A01N 37/10; A01N 37/44; A01P 21/00

(57) ABSTRACT

A compound regulator for alleviating combined drought and high-temperature stress in corn is a solution prepared by adding L-valine, phthalic acid, and a Bacillus altitudinis bacterial agent to water. An application method of the compound regulator includes: before sowing, soaking corn seeds with the solution; sowing soaked corn seeds, and measuring the germination rate when the soaked corn seeds germinate; applying the compound regulator solution to soil when corn seedlings reach a three-leaf to five-leaf stage; and 7-8 days after applying the compound regulator solution, performing analysis and statistics on a plant dry weight, a root dry weight, a plant water content, or root system indicators to obtain statistical data, and determining, based on the statistical data, effectiveness of the compound regulator on alleviating combined drought and high-temperature stress in corn. The compound regulator significantly enhances resistance of corn to the combined drought and high-temperature stress.

### CROSS-REFERENCE TO RELATED APPLICATION

This application claims priority to Chinese Patent Application No. 202411703407.0, filed Nov. 26, 2024, which is herein incorporated by reference in its entirety.

### TECHNICAL FIELD

The disclosure relates to the technical field of agriculture, and more particularly to a compound regulator for alleviating combined drought and high-temperature stress in corn (also referred to as Zea mays L. or maize) and a method of applying the compound regulator.

### BACKGROUND

The Huang-Huai-Hai region in China is a main production area for summer corn in China, and has a grain production with a significant impact on the national food supply. Influenced by global warming and monsoon climate, Henan Province in China experiences a wide variety of agricultural meteorological disasters, which are widely distributed and occur frequently, causing severe losses to agricultural production. For example, from June to August 2014, Henan Province suffered the most severe drought since 1951, with an affected area of 1.8093 million hectares (also referred to as square hundred meter, hm²) and a total crop failure area of 0.2038 million hm². Since May 2024, the rainfall in Henan Province has been more than 70% less than the multi-year average. More than half of meteorological monitoring stations have reached a moderate drought level or worse, and the scope of severe and extreme droughts continues to expand. Moreover, these extreme weather events often do not occur in isolation but occur simultaneously, exacerbating the negative impact on the summer corn yield.

Plant growth regulators are chemically synthesized (or naturally extracted from microorganisms) substances that regulate plant growth and development and have chemical properties similar to plant hormones. After crops are subjected to abiotic stress, the exogenous application of regulators can effectively alleviate the damage and reduce losses in yield and economic benefits. At present, there are many reports and mature products of regulators for crops to cope with single stress. However, regulators that can alleviate combined drought and high-temperature stress (may also be referred to as drought and heat stress, or drought and temperature stress) are rarely reported. Therefore, based on the growth characteristics of corn in the Huang-Huai-Hai region and the physiological and biochemical responses of corn under meteorological disasters, there is an urgent need to develop a compound regulator that can effectively alleviate the combined drought and high-temperature stress.

### SUMMARY

Technical problem to be solved by the disclosure is that: aiming to the current lack of a compound regulator that can effectively alleviate combined drought and high-temperature stress in corn, the disclosure provides a compound regulator for alleviating combined drought and high-temperature stress in corn and its application method. The compound regulator of the disclosure can significantly enhance the resistance of corn to the combined drought and high-temperature stress and promote root growth and development, and is of great significance for improving the production potential of the corn in the Huang-Huai-Hai region under the background of climate change.

In order to solve the above problem, technical solutions of the disclosure are as follows.

An embodiment of the disclosure provides a compound regulator for alleviating combined drought and high-temperature stress in corn. The compound regulator is a solution formulated by adding L-valine, phthalic acid, and a Bacillus altitudinis (abbreviated as BAC) bacterial agent into water.

In an embodiment, in the solution, a concentration of the L-valine is in a range of 200-500 micromoles per liter (μM), a concentration of the phthalic acid is in a range of 0.1-1 millimoles per liter (mM), and a concentration of the BAC bacterial agent is in a range of 0.1-1 grams per liter (g/L).

In an embodiment, in the solution, the concentration of the L-valine is in a range of 300-400 μM, the concentration of the phthalic acid is in a range of 0.5-1 mM, and the concentration of the BAC bacterial agent is in a range of 0.5-1 g/L.

In an embodiment, during adding the L-valine, the phthalic acid, and the BAC bacterial agent into the water to formulate the solution, for each liter of the water, an added amount of the L-valine is in a range of 0.02343-0.05857 grams (g), an added amount of the phthalic acid is in a range of 0.0166-0.166 g, and an added amount of the BAC bacterial agent is in a range of 0.1-1 g.

In addition, the disclosure provides a method of applying the compound regulator for alleviating combined drought and high-temperature stress in corn, including following steps:
a, before sowing, soaking corn seeds with the solution to improve a germination rate of the corn seeds to obtain soaked corn seeds;
b, sowing the soaked corn seeds, and measuring the germination rate when the soaked corn seeds germinate; and determining, based on the germination rate, effectiveness of the compound regulator on alleviating combined drought and high-temperature stress in corn;
c, applying the solution to soil when corn seedlings reach a three-leaf to five-leaf stage, and each of corn plants being applied with the solution of 20-30 milliliters (mL) for each time of applying the solution, so as to enhance crop growth and alleviate damage caused by the combined drought and high-temperature stress in the corn plants; and
d, 7-8 days after the applying the solution to soil, performing analysis and statistics on a plant dry weight of each of the corn plants, a root dry weight of each of the corn plants, a plant water content of each of the corn plants, or root system indicators of the corn plants to obtain statistical data, and determining, based on the statistical data, effectiveness of the compound regulator on alleviating combined drought and high-temperature stress in corn.

In an embodiment, in step a, time for the soaking corn seeds is in a range of 6-8 hours (h).

In an embodiment, in step c, a number of times of applying the solution to the soil is in a range of 2-3.

In an embodiment, in step d, the plant dry weight is a weight in grams of each of the corn plants excluding its root system after drying. The root dry weight is a weight in grams of the root system of each of the corn plants after drying. The plant water content is calculated as follows:

$$RWC = ( FW - DW ) / ( TW - DW ) \times 100 \% ,$$

where RWC represents a relative water content of a leaf, FW represents a fresh weight of the leaf, DW represents a dry weight of the leaf, and TW represents a turgid weight of the leaf.

The aboveground biomass of each treated corn plant is measured at 0 day and 10 days after drought to calculate the relative growth rate of each corn plant before and after drought. The difference in the aboveground biomass (in grams per corn plant) between 0 day and 10 days after drought is divided by a number of days between the two samplings to determine the relative growth rates of the corn plants before and after drought.

Relative growth rate=(the plant dry weight at a later time point−the plant dry weight at an earlier time point)/(T_{10d}−T_{0d}).

The root system indicators are obtained by scanning the root system of each of the corn plants with a root scanner of Epson® Scan 800F, 668403A, at a resolution of 400 dots per inch (dpi), followed by analyzing a structure of the root system by a root analysis software of WinRHIZOPro 2009 (which is a multifunctional software system used for analyzing root systems after root washing).

In an embodiment, a plant height of each corn plant is an average of heights in centimeters from a ground to leaf apexes of the corn plant.

In an embodiment, the high-temperature stress refers to a temperature greater than or equal to 35° C., for example, in a range of 38-42° C.

Embodiments of the disclosure may have the following beneficial effects.
1. The compound regulator of the disclosure can effectively promote the germination rate of the corn seeds under the combined drought and high-temperature stress, and also enhance the relative water contents of leaves and root system growth during the seedling stage. Therefore, the compound regulator of the disclosure can significantly improve the growth and development of the corn plants under the combined stress.
2. In the face of global warming, high temperatures and droughts are becoming more widespread, frequent, and severe, as major challenges to agricultural production. The disclosure alleviates the damage caused by the combined drought and high-temperature stress to the corn through the exogenous application of the compound regulator, resulting in significant improvements in the corn germination rate and seedling establishment. Therefore, the use of the compound regulator is of great significance for reducing economic losses of farmers and ensuring food security.
3. By applying the compound regulator of the disclosure, the germination rate of the corn seeds can be significantly increased, roots can grow deeper, and the damage to the corn plants caused by the combined drought and high-temperature stress can be reduced.
4. The compound regulator of the disclosure is easy to prepare, convenient to apply, and cost-effective, making it suitable for large-scale promotion and use.

In summary, the compound regulator product of the disclosure can significantly enhance the resistance of the corn to the combined drought and high-temperature stress and promote root growth and development. The compound regulator of the disclosure is of great significance for improving the production potential of the corn in the Huang-Huai-Hai region under the background of climate change.

### BRIEF DESCRIPTION OF DRAWINGS

FIG. 1 illustrates a schematic diagram of corn phenotypes under combined drought and high-temperature stress with different concentrations of L-valine.

FIGS. 2A-2E illustrate schematic diagrams of influence of the different concentrations of L-valine on aboveground parts and root systems of corn under the combined drought and high-temperature stress.

FIG. 3 illustrates a schematic diagram of corn phenotypes under the combined drought and high-temperature stress with different concentrations of phthalic acid.

FIGS. 4A-4D illustrate schematic diagrams of influence of the different concentrations of phthalic acid on the aboveground parts and the root systems of the corn under the combined drought and high-temperature stress.

FIG. 5 illustrates a schematic diagram of corn phenotypes under the combined drought and high-temperature stress with different concentrations of D-fructose.

FIGS. 6A-6D illustrate schematic diagrams of influence of the different concentrations of D-fructose on the aboveground parts and the root systems of the corn under the combined drought and high-temperature stress.

FIG. 7 illustrates a schematic diagram of corn phenotypes under the combined drought and high-temperature stress with different concentrations of glutathione.

FIGS. 8A-8D illustrate schematic diagrams of influence of the different concentrations of glutathione on the aboveground parts and the root systems of the corn under the combined drought and high-temperature stress.

FIG. 9 illustrates a schematic diagram of corn phenotypes under the combined drought and high-temperature stress with different concentrations of orotic acid.

FIGS. 10A-10D illustrate schematic diagrams of influence of the different concentrations of orotic acid on the aboveground parts and the root systems of the corn under the combined drought and high-temperature stress.

FIG. 11 illustrates a schematic diagram of corn phenotypes under the combined drought and high-temperature stress with different concentrations of BAC bacterial agent.

FIGS. 12A-12E illustrate schematic diagrams of influence of the different concentrations of BAC bacterial agent on the aboveground parts and the root systems of the corn under the combined drought and high-temperature stress.

FIG. 13 illustrates a schematic diagram of corn phenotypes under the combined drought and high-temperature stress with different compound combinations.

FIGS. 14A-14E illustrate schematic diagrams of influence of the different compound combinations on the aboveground parts and the root systems of the corn under the combined drought and high-temperature stress.

FIG. 15 illustrates a schematic diagram of influence of different regulatory substances on corn seed germination.

FIG. 16 illustrates a schematic diagram of corn phenotypes under the combined drought and high-temperature stress with single substances and a compound combination.

FIGS. 17A-17E illustrate schematic diagrams of influence of the single substances and the compound combination on the aboveground parts and the root systems of the corn under the combined drought and high-temperature stress.

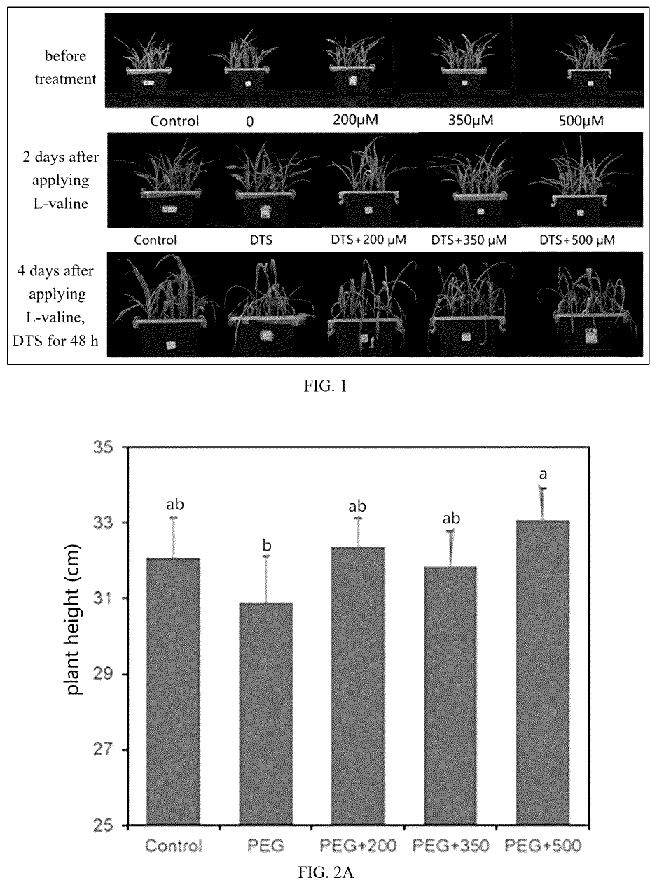

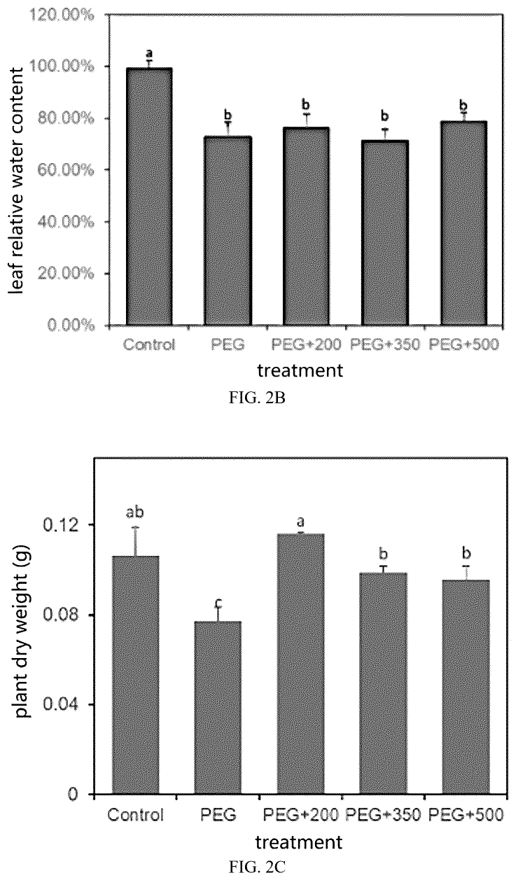

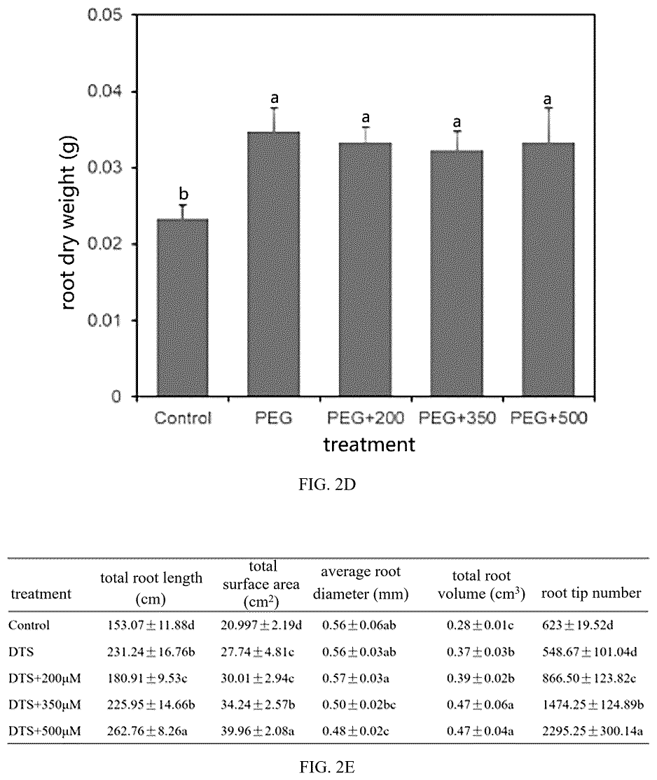

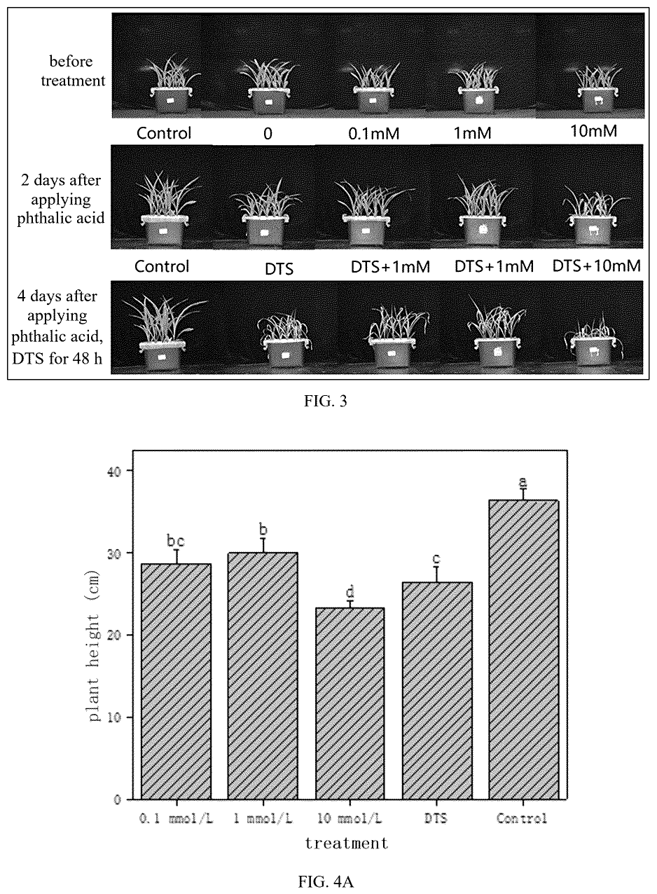

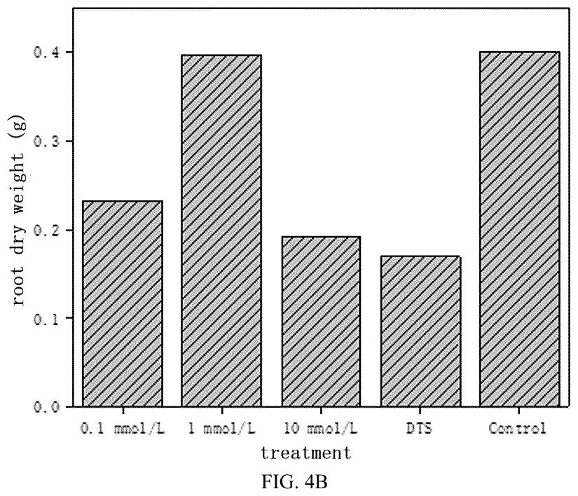

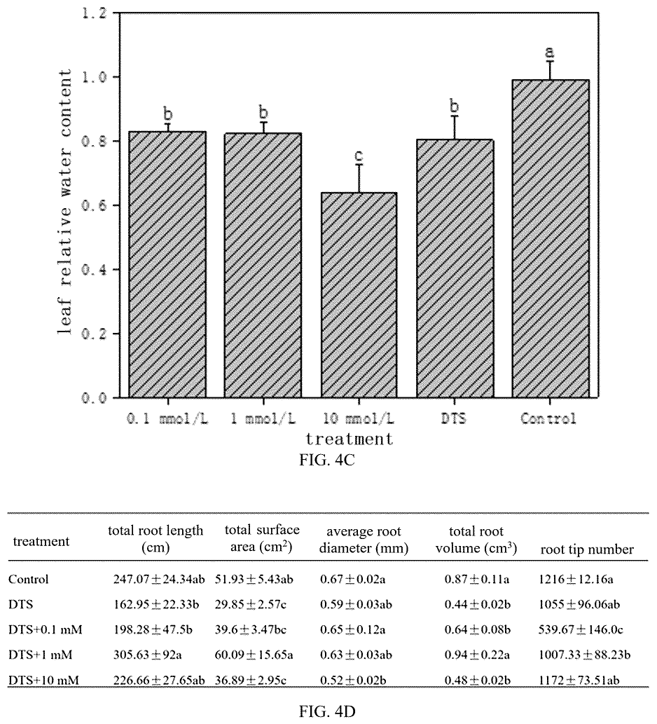

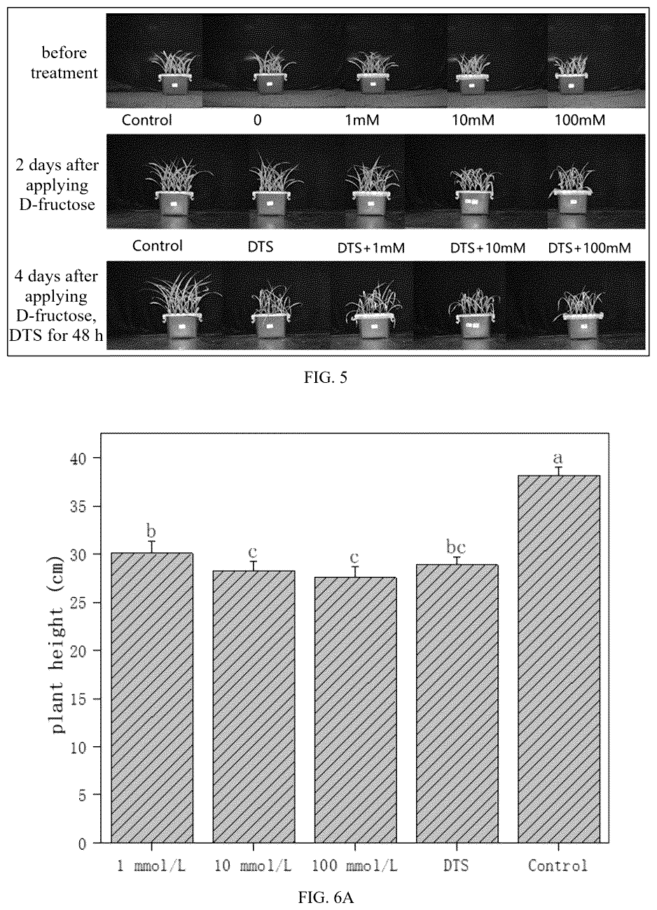

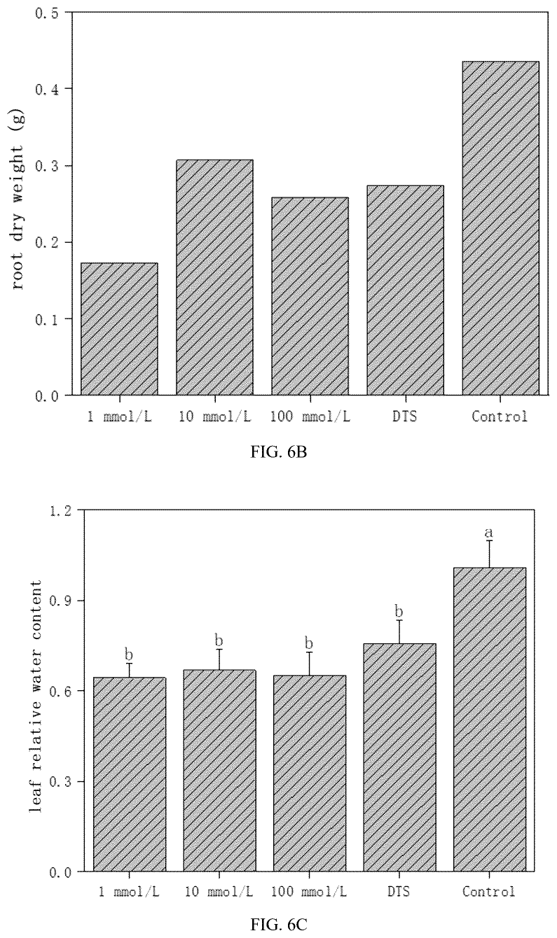

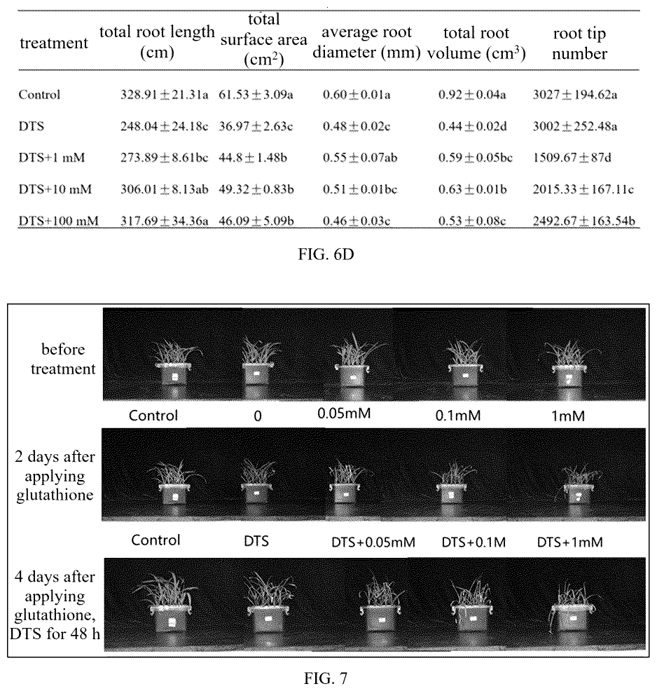

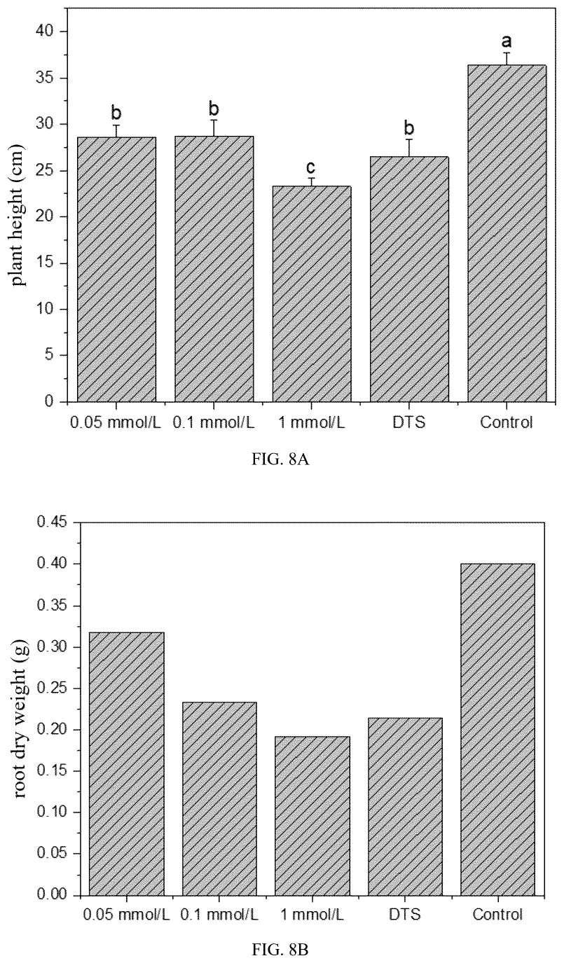

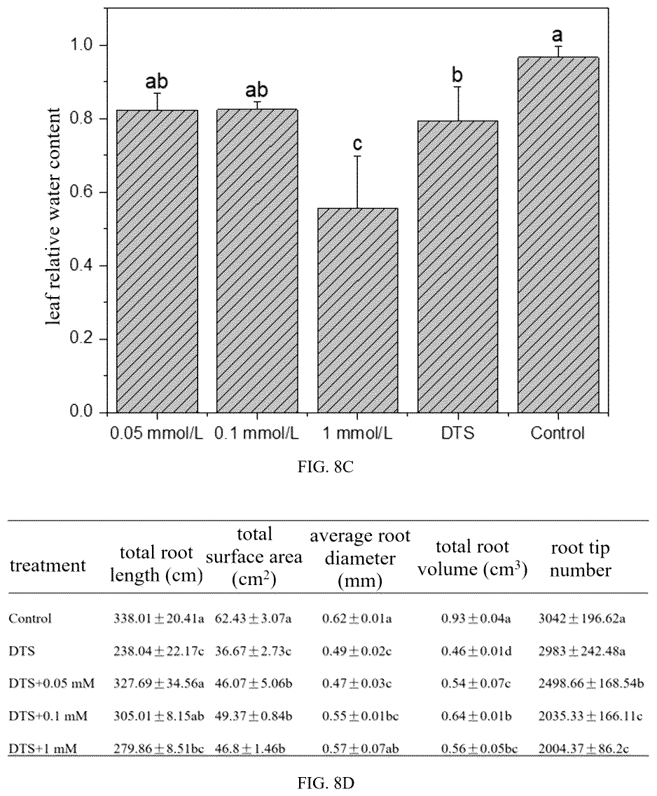

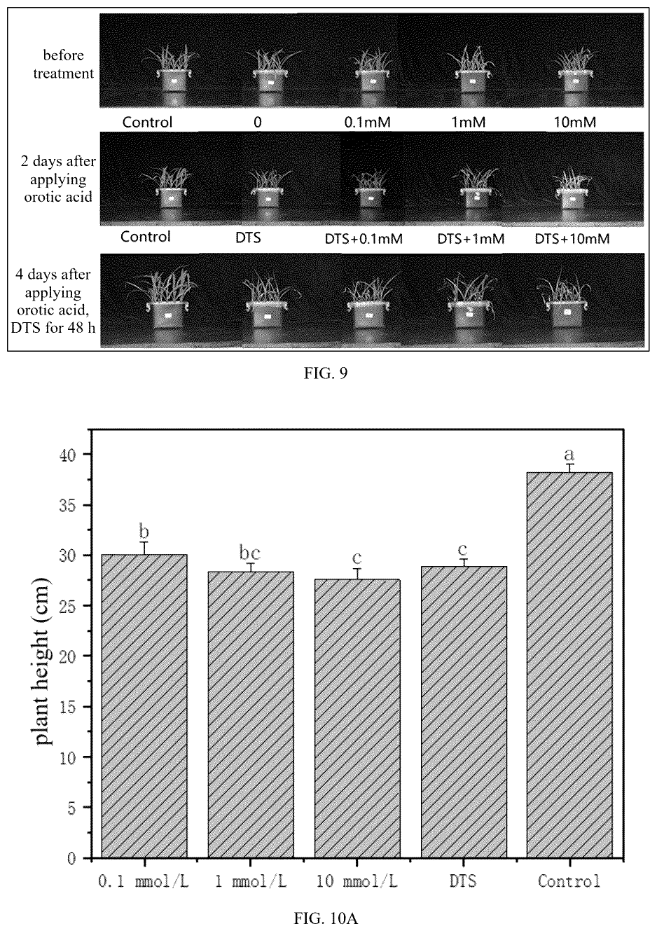

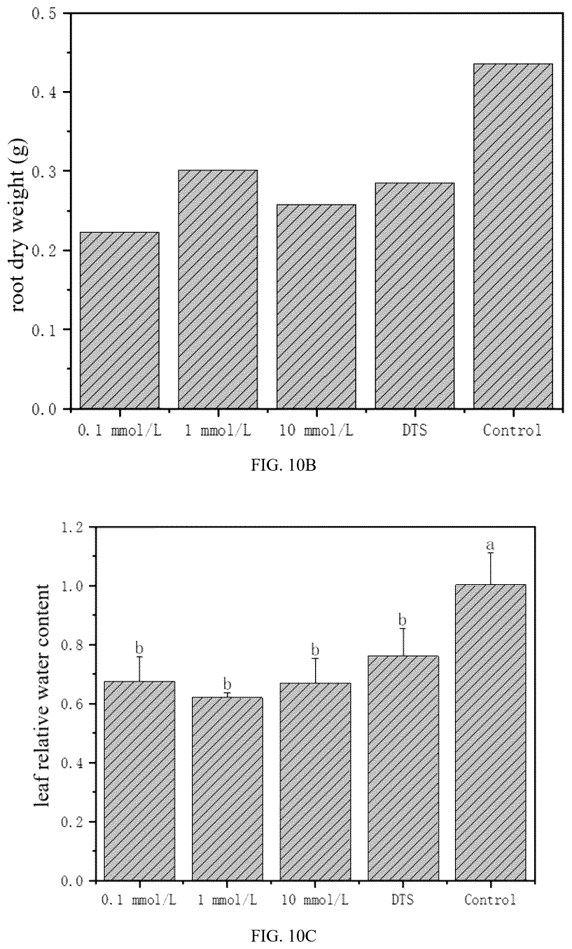

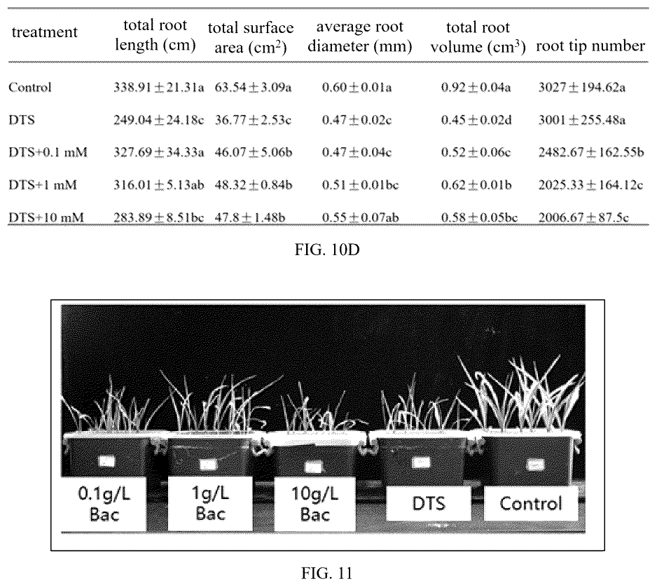

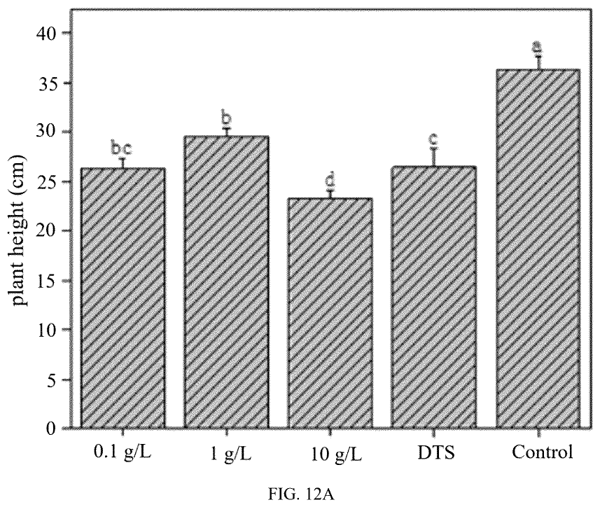

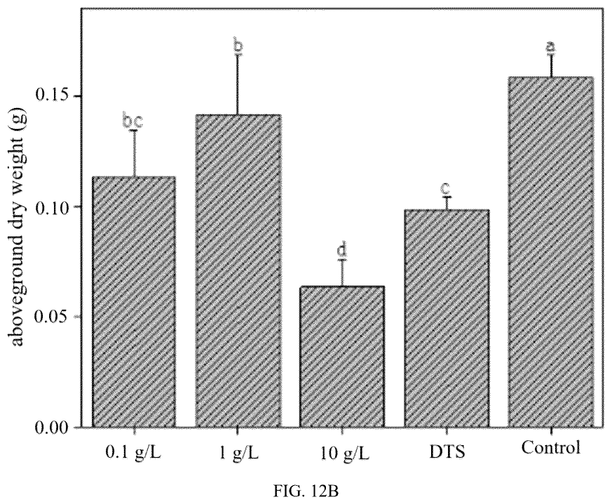

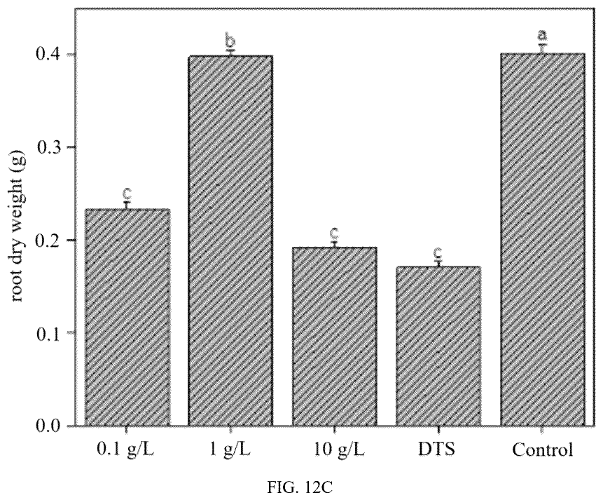

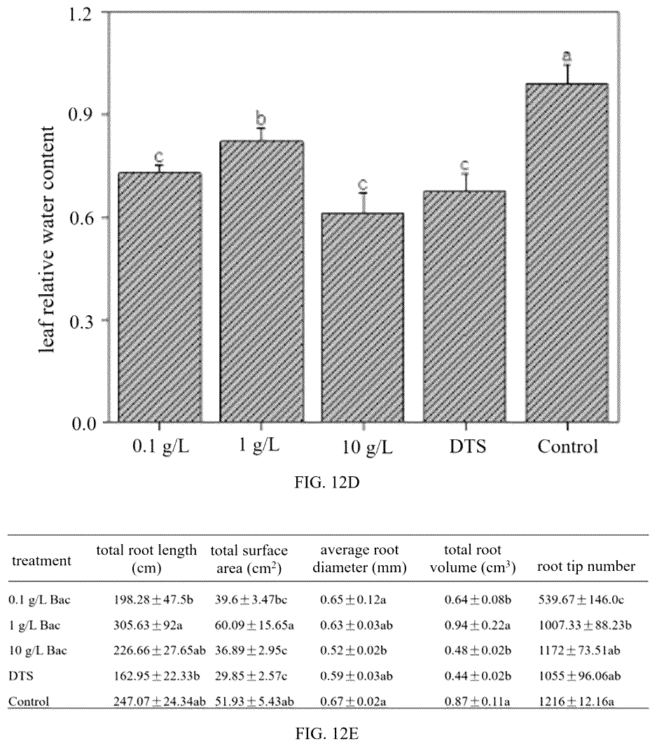

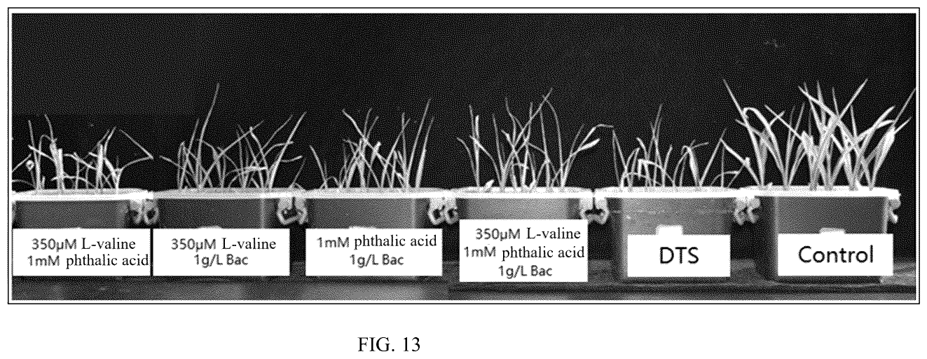

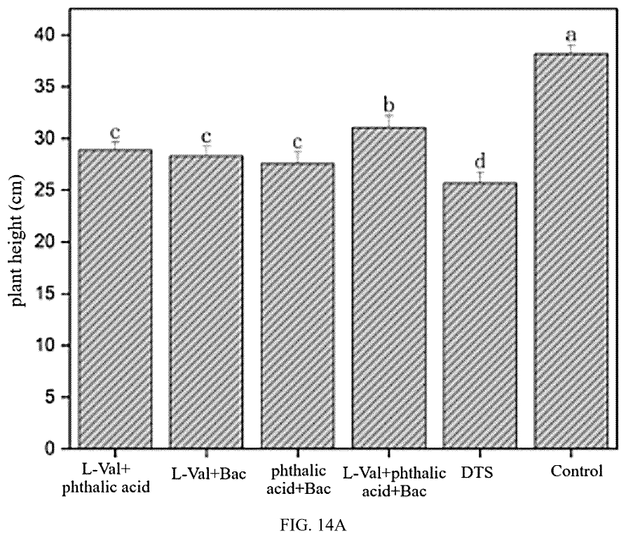

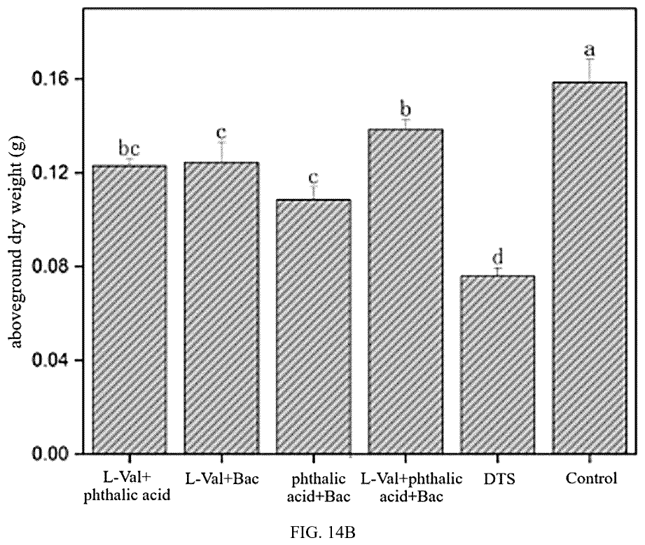

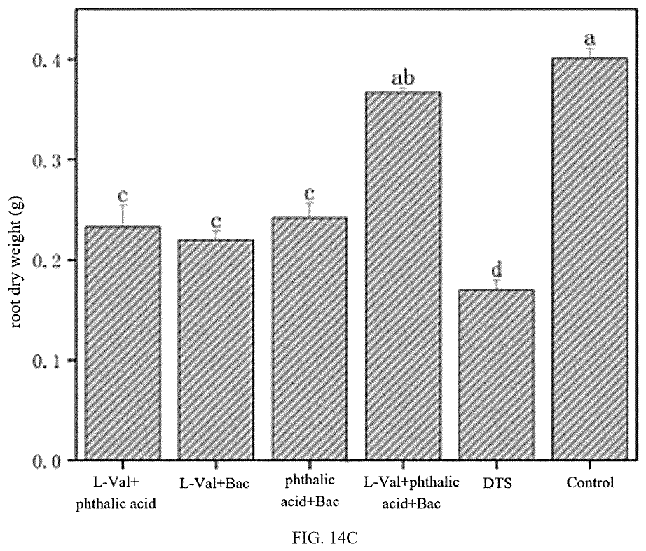

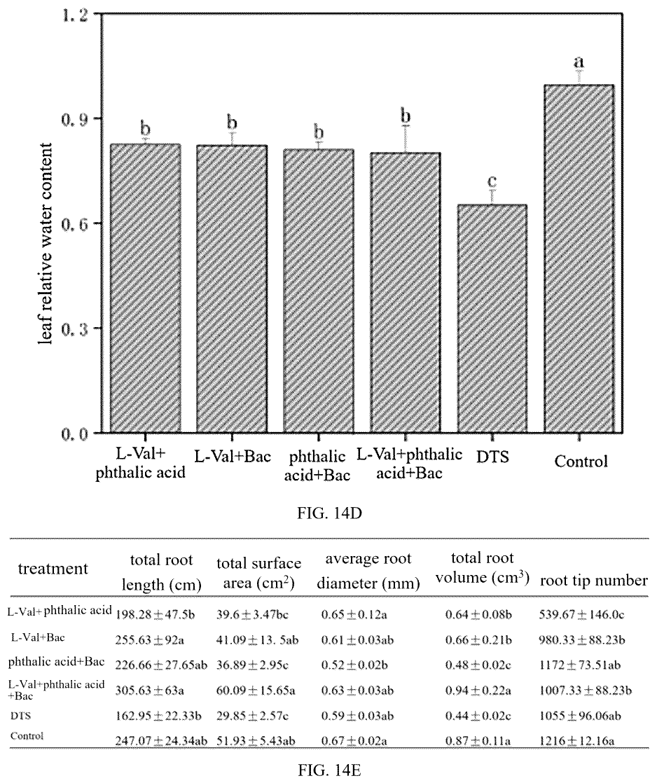

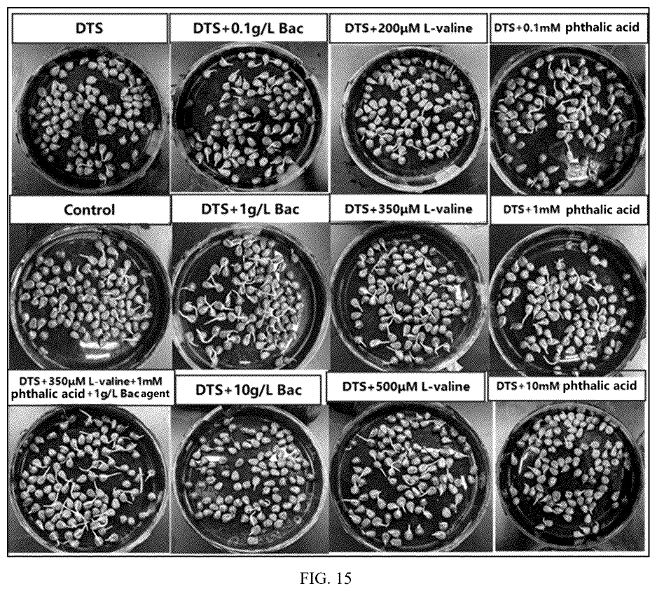

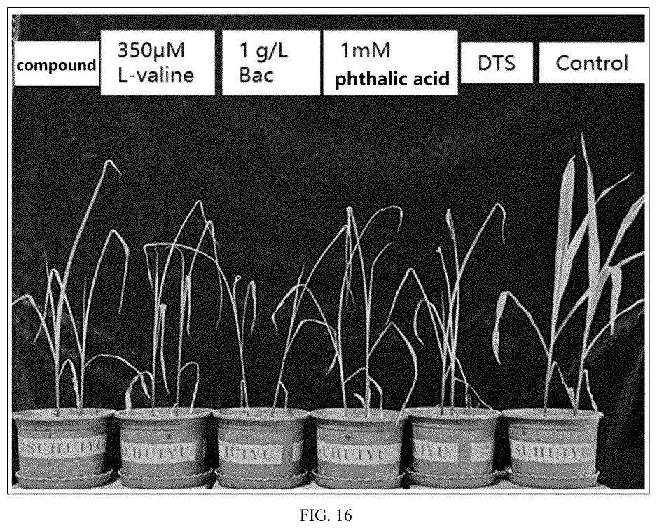

Types and concentration ranges of regulators that significantly alleviate the combined drought and high-temperature stress can be initially screened through FIGS. 1-12E. It can be preliminarily verified through FIGS. 13-14E that the compound regulator composed of three substances shows significantly higher relative water content of leaves, root dry weight, and total root volume compared to the effects of pairwise combinations. FIGS. 15-17E show that the compound regulator significantly promotes the corn seed germination, increases the germination rate, and also significantly enhances the corn root dry weight, the total root length, and the root tip number, effectively alleviating the damage caused by the combined drought and high-temperature stress.

### DETAILED DESCRIPTION OF EMBODIMENTS

Following embodiments are used to further illustrate the disclosure, but do not limit the scope of protection of technical solutions of the disclosure.

The optimization process of L-valine, phthalic acid, and a BAC bacterial agent used in a compound regulator of the disclosure is as follows.
1. Used materials includes: a corn cultivar: Xianyu 335 (Pioneer Hi-Bred International, Inc.), the Bac agent (i.e., the BAC bacterial agent), the L-valine (CAS: 72-18-4), the phthalic acid (CAS: 88-99-3), D-fructose (CAS: 57-48-7), orotic acid (CAS: 65-86-1), and L-glutathione (CAS: 27025-41-8). A nutrient solution includes: a Hoagland nutrient solution (Hoagland of 1.26 g/L+calcium salt of 0.945 g/L), 20% macrogol 6000 (also referred to as polyethylene glycol 6000, PEG 6000) is used to simulate drought stress. A constant temperature incubator and a smart greenhouse are used to achieve high-temperature stress.
2. A hydroponic screening test method and results are as follows.

After performing analysis on rhizosphere metabolomics of corn under a drought condition, a high-temperature condition, a combined drought and high-temperature stress (DTS) condition and a control condition, significantly upregulated metabolites under the combined drought and high-temperature stress are found to be the L-valine, the phthalic acid, the D-fructose, the glutathione, and the orotic acid. In order to further verify whether these regulators could enhance the resistance of the corn to high temperature and drought, hydroponic tests are conducted under indoor conditions. The drought stress is simulated by using the 20% PEG 6000, and the temperature stress is simulated by using the incubator at a temperature in a range of 38-42° C. Different concentrations of exogenous regulators are applied to the corn rhizosphere under the combined drought and high-temperature stress. An optimal concentration for alleviating the combined drought and high-temperature stress is screened by measuring a biomass, a plant height, a leaf relative water content, and root development indicators.

The results are as follows. It can be concluded from FIGS. 1-12E that, compared with the DTS treatment, the DTS+350 μM L-valine treatment significantly increased the plant height by 9.55%, the plant dry weight by 27.74%, and the root dry weight by 28.93%; the DTS +1 mM phthalic acid treatment significantly increased the plant height by 13.5% and an aboveground dry weight by 43.9%, and also significantly increased a total root length and a total root surface area; the application of different concentrations of glutathione and orotic acid under the combined drought and high-temperature stress did not effectively alleviate the stress; the DTS+1 g/L Bac agent treatment significantly increased the aboveground dry weight by 43.9% and the leaf relative water content by 21.5%, and also significantly increased the root dry weight, the total root length, and the total root volume. Based on the above experimental results, the disclosure has identified substances that can effectively alleviate the combined drought and high-temperature stress. Subsequently, the disclosure conducted experiments using a combination of multiple substances to enhance the effectiveness of the regulator (see FIGS. 13-14E). The results show that the compound of the L-valine, the phthalic acid, and the Bac agent is more effective in promoting corn growth and development under the combined drought and high-temperature stress than pairwise combinations, mainly reflected in the plant dry weight, the root dry weight, and the total root volume.

### Embodiment 1

An embodiment of the disclosure provides a compound regulator solution for alleviating combined drought and high-temperature stress in corn. The compound regulator solution is formulated by adding 0.041 g of the L-valine, 0.166 g of the phthalic acid, 1 g of the BAC bacterial agent into 1 L of water. In the compound regulator solution, a concentration of the L-valine is 350 μM, a concentration of the phthalic acid is 1 mM, and a concentration of the BAC bacterial agent is 1 g/L.

### Embodiment 2

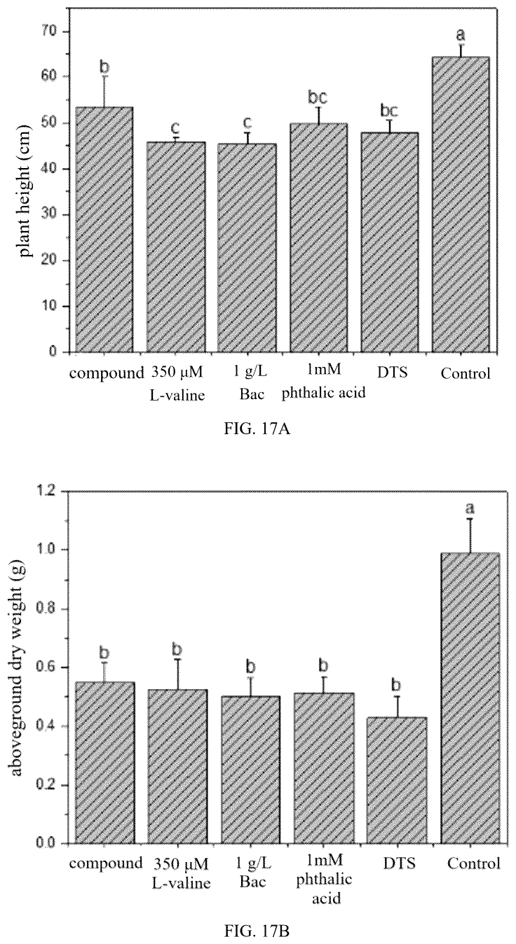

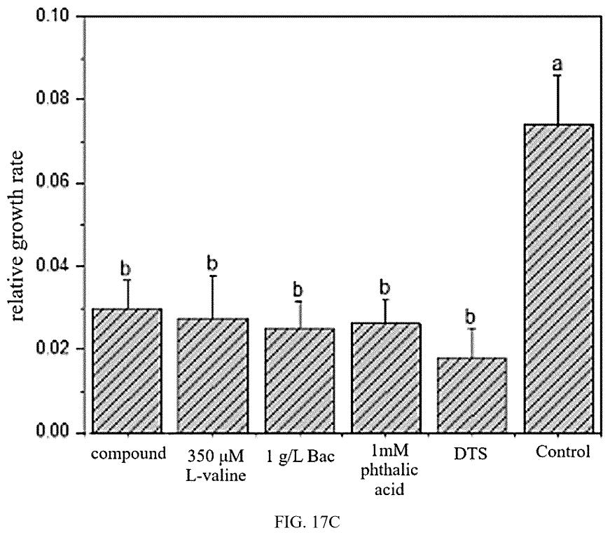

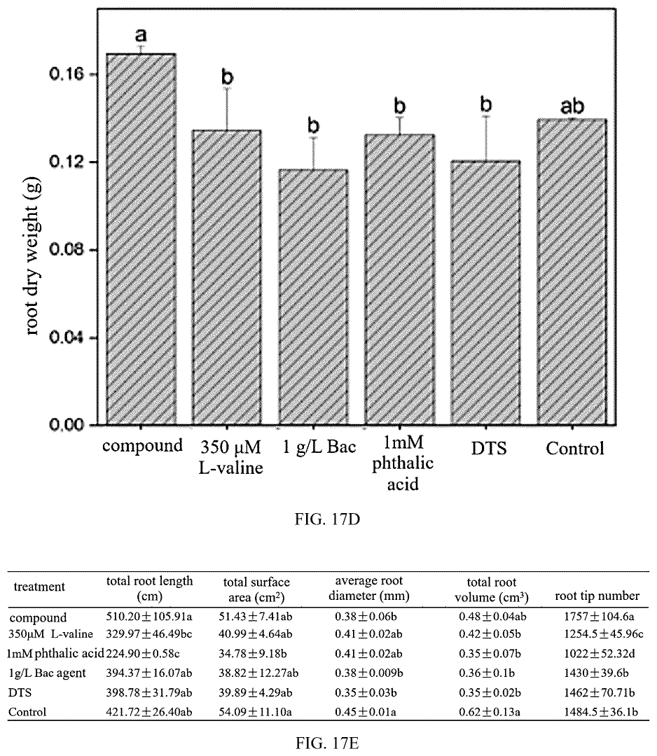

An application method of the compound regulator for alleviating combined drought and high-temperature stress in corn provided by the embodiment 1 of the disclosure, includes following steps:
a, before sowing, soaking corn seeds with the compound regulator solution for 8 h to improve a germination rate of the corn seeds to obtain soaked corn seeds;
b, sowing the soaked corn seeds, and measuring the germination rate when the soaked corn seeds germinate (results are shown in Table 1, the germination rate reaches 87.64%);
c, applying the compound regulator solution to soil when corn seedlings reach a three-leaf to five-leaf stage, with a volume of the compound regulator solution being 20 mL per corn plant for each time of applying the compound regulator solution, and three total times of applying the compound regulator solution (with a one-day interval between two times of applying the compound regulator solution), thereby enhancing crop growth and alleviating damage caused by the combined drought and high-temperature stress in the corn plants; and
d, 7 days after the applying the compound regulator solution to soil, performing analysis and statistics on a plant dry weight of each corn plant, a root dry weight of each corn plant, a plant water content of each corn plant, and root system indicators of the corn plants, with analyzing results shown in FIGS. 17A-17E.

It can be seen from FIGS. 17A-17E that, compared with the DTS treatment, the compound regulator treatment increases the root dry weight by 40.7%, the root tip number by 20.2%, the plant height by 12.0%, the aboveground dry weight by 27.9%, and the relative growth rate by 66.7%.

In the embodiment, the combined drought and high-temperature stress condition includes: a field capacity (also referred to as a soil water content) in a range of 40%-50%, and a greenhouse temperature in a range of 38-42° C. The control condition includes: a field capacity in a range of 75%-85%, and an atmospheric temperature in a range of 28-32° C.

During the application process in the embodiment, comparative examples are also set up, and details of the comparative examples are shown in FIG. 15 and Table 1.

TABLE 1
influence of different regulatory substances
on the germination rate of corn seeds.

| Treatment | Germination rate in 3 days |
|---|---|
| Control | 68.45% |
| DTS | 40.55% |
| DTS + 350 μmol/L L-valine + 1 mM | 87.64% |
| phthalic acid + 1 g/L Bac agent | |
| DTS + 0.1 g/L Bac | 65.33% |
| DTS + 1 g/L Bac | 73.50% |
| DTS + 10 g/L Bac | 37.52% |
| DTS + 200 μM L-valine | 77.90% |
| DTS + 350 μM L-valine | 80.65% |
| DTS + 500 μM L-valine | 75.25% e |
| DTS + 0.1 mM phthalic acid | 79.54% |
| DTS + 1 mM phthalic acid | 80.32% |
| DTS + 10 mM phthalic acid | 45.46% |

In summary, the compound regulator of the disclosure can significantly enhance crop growth, alleviate the damage caused by the combined drought and high-temperature stress to plants, and improve the water use efficiency and root growth of crops.

What is claimed is:

1. A compound regulator for alleviating combined drought and high-temperature stress in corn, wherein the compound regulator is a solution formulated by adding L-valine, phthalic acid, and a Bacillus altitudinis (BAC) bacterial agent into water.

2. The compound regulator for alleviating combined drought and high-temperature stress in corn as claimed in claim 1, wherein in the solution, a concentration of the L-valine is in a range of 200-500 micromoles per liter (μM), a concentration of the phthalic acid is in a range of 0.1-1 millimoles per liter (mM), and a concentration of the BAC bacterial agent is in a range of 0.1-1 grams per liter (g/L).

3. The compound regulator for alleviating combined drought and high-temperature stress in corn as claimed in claim 2, wherein in the solution, the concentration of the L-valine is in a range of 300-400 μM, the concentration of the phthalic acid is in a range of 0.5-1 mM, and the concentration of the BAC bacterial agent is in a range of 0.5-1 g/L.

4. The compound regulator for alleviating combined drought and high-temperature stress in corn as claimed in claim 1, wherein during adding the L-valine, the phthalic acid, and the BAC bacterial agent into the water to formulate the solution, for each liter of the water, an added amount of the L-valine is in a range of 0.02343-0.05857 grams (g), an added amount of the phthalic acid is in a range of 0.0166-0.166 g, and an added amount of the BAC bacterial agent BAC is in a range of 0.1-1 g.

5. A method of applying the compound regulator for alleviating combined drought and high-temperature stress in corn as claimed in claim 1, comprising following steps;
a, before sowing, soaking corn seeds with the solution to improve a germination rate of the corn seeds to obtain soaked corn seeds;
b, sowing the soaked corn seeds, and measuring the germination rate when the soaked corn seeds germinate; and determining, based on the germination rate, effectiveness of the compound regulator on alleviating combined drought and high-temperature stress in corn;
c, applying the solution to soil when corn seedlings reach a three-leaf to five-leaf stage, and each of corn plants being applied with the solution of 20-30 milliliters (mL) for each time of applying the solution, so as to enhance crop growth and alleviate damage caused by the combined drought and high-temperature stress in the corn plants; and
d, 7-8 days after the applying the solution to soil, performing analysis and statistics on a plant dry weight of each of the corn plants, a root dry weight of each of the corn plants, a plant water content of each of the corn plants, or root system indicators of the corn plants to obtain statistical data, and determining, based on the statistical data, effectiveness of the compound regulator on alleviating combined drought and high-temperature stress in corn.

6. The method of applying the compound regulator for alleviating combined drought and high-temperature stress in corn as claimed in claim 5, wherein in step a, time for the soaking corn seeds is in a range of 6-8 hours (h).

7. The method of applying the compound regulator for alleviating combined drought and high-temperature stress in corn as claimed in claim 5, wherein in step c, a number of times of applying the solution to the soil is in a range of 2-3.

8. The method of applying the compound regulator for alleviating combined drought and high-temperature stress in corn as claimed in claim 5, wherein in step d, the plant dry weight is a weight in grams of each of the corn plants excluding its root system after drying; the root dry weight is a weight in grams of the root system of each of the corn plants after drying;
wherein the plant water content is calculated as follows:
$$RWC = ( FW - DW ) / ( TW - DW ) \times 100 \% ,$$
where RWC represents a relative water content of a leaf, FW represents a fresh weight of the leaf, DW represents a dry weight of the leaf, and TW represents a turgid weight of the leaf; and
wherein the root system indicators are obtained by scanning the root system of each of the corn plants at a resolution of 400 dots per inch (dpi) using a root scanner of Epson® Scan 800F, 668403A, followed by analyzing a structure of the root system using a root analysis software of WinRHIZOPro 2009.

9. The method of applying the compound regulator for alleviating combined drought and high-temperature stress in corn as claimed in claim 8, wherein a plant height of each of the corn plants is an average of heights in centimeters from a ground to leaf apexes of the corn plant.
